(19) United States
(12) Patent Application Publication
(10) Pub. No.: US 2026/0225253 A1
(43) Pub. Date: Aug. 6, 2026

(54) METHOD AND DEVICE FOR AUTOMATICALLY LOCATING OBJECTS SUITABLE FOR REMOVAL FROM AN OBJECT CLUSTER

(71) Applicant: ISRA VISION GMBH, Darmstadt (DE)

(72) Inventors: Manuel SCHOLZ, Darmstadt (DE); Steffen WIRSCHING, Darmstadt (DE); Tim HARTTER, Seeheim-Jugenheim (DE); Janina HORLEBEIN, Darmstadt (DE)

(21) Appl. No.: 19/150,320

(22) PCT Filed: Dec. 8, 2023
(86) PCT No.: PCT/EP2023/084983

§ 371 Date: Jul. 23, 2025

(30) Foreign Application Priority Data
Jan. 24, 2023 (DE) 10 2023 101 672.5

(51) Int. Cl. B25J 9/16; G06T 7/12; G06T 7/50; G06T 7/70; G06V 10/762; G06V 10/776; G06V 10/82

(52) U.S. Cl. CPC B25J 9/1697; B25J 9/1679; G06T 7/12; G06T 7/50; G06T 7/70; G06V 10/762; G06V 10/776; G06V 10/82; G06T 2207/20081; G06T 2207/20084

(57) ABSTRACT

A safe and reliable method for automatically locating objects of an observed area of an object cluster in an open container having a plurality of objects of at least one object type. The method includes: receiving a data model of the at least one object type, receiving a trained NN algorithm trained based on the data model of the at least one object type, receiving an elevation map of the observed area of object cluster, identifying a plurality of objects lying on the top side of the observed area of the object cluster and determining the 3-dimensional position and orientation of these objects based on the trained NN algorithm and using exclusively the elevation map with respect to the observed area, and providing the 3-dimensional position and orientation of the plurality of objects lying on the top side of the observed area of the object cluster at an interface of the data processing unit.

The invention relates to a method and a device for automatically locating of objects from an object cluster consisting of a plurality of objects of at least one object type arranged one above the other and/or adjacently, for example for the removal of objects from an object cluster present in an open container, using an artificial neural network, a system for the corresponding control of a gripping and/or transport element for removing or manipulating such an object from the object cluster or for controlling a robot element for assuming a predetermined position relative to an object from the object cluster, and the corresponding training of the artificial neural network.

The automatic identification and localization of objects from an object cluster arranged in a container is an important application of robotics. For example, it is desirable that components that have been randomly poured into an open-top component container or stacked in a predetermined manner are automatically removed individually by means of a gripper and transport arm and transported to a predetermined position (e.g. a conveyor belt or a machine), where they are then used further. The removal of objects from the container is also known as bin-picking. The identification and localization of objects in an object cluster is also interesting for line tracking of objects or visual servoing. In visual servoing, the movement of a robot element in relation to a moving object is controlled based on information obtained from an image sensor (visual feedback). With line tracking, on the other hand, a moving object is observed by optical means and a moving gripper and/or transport element is controlled accordingly to manipulate the object.

The automatic recognition of 3-dimensional objects by means of artificial intelligence and in particular by means of artificial neural networks (hereinafter referred to as NN algorithm) has already been described many times. From the documents DE 10 2022 107 311 A1 and DE 10 2022 107 228A1, methods are known in which objects in a container are recognized and removed from the container. The comparatively complicated methods are based on the use of 2D RGB color images of the object cluster, which are subjected to an image segmentation process by means of a neural network.

Based on the above prior art, the object is to specify a simple, safe and reliable method for automatically locating of objects from an object cluster consisting of a plurality of objects of at least one object type arranged one above the other and/or adjacently, and to create a device which implements such a method. Furthermore, the object is to provide a safe and reliably operating system for controlling the movement of a gripping and/or transporting element which removes or manipulates an object from such an object cluster, or for controlling the movement of a robotic element so that it takes a predetermined position relative to an object from the object cluster.

The above object is solved by methods for automatically locating of objects from an object cluster consisting of a plurality of objects of at least one object type arranged one above the other and/or adjacently with the features of claim 1, a corresponding device with the features of claim 9, a method and a system for controlling a movable gripping and/or transporting element for removing or manipulating an object from the object cluster with the features of claims 5, 7, 12, 14 or a method and a system for controlling a movable robot element so that it takes a predetermined position relative to an object of the object cluster, having the features of claims 8, 15, and by a method for automatically training an NN algorithm for identifying and locating objects suitable for removal from an object cluster present in an open container by means of a data processing unit having the features of claim 16.

In particular, the above object is solved by a method for automatically locating objects of an observed area of an object cluster consisting of a plurality of objects of at least one object type arranged one above the other and/or adjacently, comprising the following steps:
Receiving a data model of the at least one object type, for example in the form of a colored coordinate model,
Receiving an NN algorithm trained for the specific at least one object type, wherein the NN algorithm is trained based on the data model of the at least one object type,
Receiving an elevation map of the observed area of the object cluster,
Identifying a plurality of objects arranged in the observed area of the object cluster and determining the 3-dimensional position and orientation of said plurality of objects in a predetermined coordinate system by means of a data processing unit based on the NN algorithm trained with respect to the at least one object type using the data model of the at least one object type and using exclusively the elevation map of the observed area of the object cluster with respect to the observed area,
Providing the 3-dimensional position and orientation of the plurality of objects arranged in the observed area of the object cluster at an interface of the data processing unit.

Here, the data model of the at least one object type and the NN algorithm trained for the at least one object type is usually received once at the beginning of the use of the method in a machine or on a conveyor belt. If necessary, the NN algorithm is updated from time to time during further use of the method (e.g. after further training) or the data model and the NN algorithm are supplemented/changed when the object types change. In contrast, the elevation map of the observed area of the object cluster is received repeatedly—as shown below, for example, at predetermined time points after it has been determined and transmitted using a 3D scanner, for example. Accordingly, on the basis of each elevation map, the plurality of objects arranged in the area of the object cluster is identified and their 3-dimensional position and orientation are determined and made available at the interface of the data processing unit.

In one embodiment, the above method is used for automatically locating of objects suitable for removal from an observed area of an object cluster present in an open container consisting of a plurality of objects of at least one object type lying on top of one another, comprising the following steps:
Receiving a data model of the at least one object type, for example in the form of a colored coordinate model,
Receiving an NN algorithm trained for the specific at least one object type, wherein the NN algorithm is trained based on the data model of the at least one object type,
Receiving an elevation map of the observed area of the object cluster,
Identifying a plurality of objects lying on the top side of the observed area of the object cluster, and determining the 3-dimensional position and orientation of said plurality of objects lying on the top side of the object cluster in a predetermined coordinate system by means of a data processing unit based on the NN algorithm trained with respect to the at least one object type using the data model of the at least one object type and using exclusively the elevation map of the observed area of the object cluster with respect to the observed area,
Providing the 3-dimensional position and orientation of the plurality of objects lying on the top side of the observed area of the object cluster at an interface of the data processing unit.

The above method is usually realized as a computer-implemented method by means of a data processing unit (e.g. a computer) having a processor and a memory unit readable by the processor.

The method is intended to identify 3-dimensional objects (e.g. components) arranged in an observed area (a section) of an object cluster, which are arranged in a container, for example in an object cluster accessible from one side (e.g. from above), and to determine (locate) their position and orientation (pose) in a predetermined coordinate system (e.g. the coordinate system of a movable gripping and/or transport element, of a movable robot element or of a 3D scanner). A control device of the movable gripping and/or transport element or of the movable robot element may receive this data and determine control signals, by means of which it then removes or manipulates the identified object from the container and, if necessary, transports it to a position or moves the movable robot element relatively.

The method includes the steps in which a data model of the at least one object type (i.e. possibly several object types) and possibly a data model of the container is transmitted, for example in each case data from a CAD model. In addition, a specific NN algorithm trained for the at least one object type and possibly the respective container is received, wherein, in the case of several object types, an object type-specific NN algorithm may be used for each object type (i.e. for 2 or 3 object types, for example, corresponding to 2 or 3 NN algorithms) or a single NN algorithm trained jointly for the respective object types. This data is stored in the memory unit and made available for the respective processing of the procedure. The data model of an object type and, if applicable, the container is the software-side realization of the dimensions of a (virtual) object and container, respectively. When using several different objects (e.g. components), the object cluster includes in particular one or more objects of each object type, wherein cases may also occur in which one or more object types are not present.

Furthermore, an elevation map of an observed area of a current object cluster may be determined by means of a 3D scanner (which comprises, for example, at least two cameras with corresponding data processing, which look at the observed area from different directions). The elevation map contains a large number of pixels in two dimensions (x/y), wherein the position of the respective point on the surface of the object cluster is coded as a corresponding gray value for each pixel. For example, pixels without an object and at the greatest distance from the 3D scanner, respectively, may be shown in white and object pixels at the smallest distance from the 3D scanner may be shown in black in the elevation map. Such an elevation map is shown in FIG. 20, for example, and is provided with the reference sign 91.

In addition, in an embodiment of the method, a data model of the container in which the objects are usually arranged, for example in the form of a colored coordinate model, may also be included and received accordingly. Accordingly, the NN algorithm may additionally be trained based on the data model of the at least one container. In this embodiment, this NN algorithm trained on the at least one object type and the at least one container may be used as a basis for identifying the plurality of objects lying on the top side of the observed area of the object cluster and determining the 3-dimensional position and orientation of this plurality of objects lying on the top side of the object cluster in the predetermined coordinate system by means of the data processing unit.

According to the method of the invention, the data model of the at least one object type and possibly the container as well as the currently determined elevation map of the observed area are used in the NN algorithm to determine a plurality of objects arranged in the observed area of the object cluster, e.g. objects located on the top side of the object cluster (wherein the identification may include the recognition of the respective object type if different object types may be present in the object cluster) and to determine the position and orientation of the identified objects. No further camera images or other data of the observed area are required. With regard to the observed area, exclusively the elevation map of the respective observed area is required to identify the plurality of objects in the observed area and their 3-dimensional position and orientation as “measurement parameters” or measured/actual input. In the case of continuous removal of objects from a container/manipulation of an object from an object cluster/movement of a robot element relative to an object from an object cluster, exclusively the current elevation map of the observed area needs to be generated as input for the NN algorithm, possibly repeatedly at predefined time points. Objects (for example the removable objects lying on the top side) may thus be continuously identified using the elevation map and the method according to the invention, and their 3-dimensional position (in the specified coordinate system) and their 3-dimensional orientation determined quickly and easily (the term 3-dimensional position and orientation includes the 3-dimensional position and orientation in three dimensions). This enables the gripping and/or transporting element to move in such a way that the gripping and/or transporting element in each case records an object and transports it to the desired position or manipulates the object. Accordingly, a robot element is enabled to move in such a way that it takes at least one predetermined position relative to an object from the object cluster. As soon as the 3-dimensional position and orientation of the identified objects suitable for removal have been determined, these are provided to a corresponding interface of the data processing unit. This data may then be further processed by a control device of the gripping and/or transport element or the robot element into corresponding control signals of the gripping and/or transport element or robot element. In this case, if several object types may be present in the observed area, the information available at the interface of the data processing unit naturally also includes an indication of the object type to which the respective identified object, for which the 3-dimensional position and orientation was determined, belongs.

As will be shown in more detail below, the method has proven to be very robust, reliable and fast as well as safe in determining the position and/or orientation of objects in a predetermined 3-dimensional coordinate system. In addition, it is sufficient to provide exclusively the elevation map of the observed area. The method may be used for any object types, container shapes and container dimensions as well as movements of the objects of the object cluster. The method can also be used if the environment of the object cluster changes. The NN algorithm is trained separately for each object type and for each plurality of object types, respectively, so that, in particular, an NN algorithm trained for the respective plurality of object types is used for the above method. The method can therefore be adapted to different object types and the number of object types. The method has proven to be variable with regard to possible container shapes and sizes or movements of the objects.

The NN algorithm used is an assignment based on a neural network. The NN algorithm uses the neural network to assign to the received elevation map a plurality of objects arranged one above the other and/or adjacently in the observed area, e.g. a plurality of objects lying on the top side of the observed area of the object cluster, and their 3-dimensional position and orientation in the predetermined coordinate system. In one embodiment, the neural network is a convolutional neural network (CNN) that generates, for example, a map from the elevation map that illustrates the object coordinates of the objects in the observed area in a coordinate system of the respective object. For example, a neural network based on the U-Net architecture is used for this purpose and has proven to be very suitable for such image-to-image translation problems.

In this embodiment, the U-network of the CNN may consist of three sections: the contraction section, the bottleneck section and the expansion section. The contraction section contains many contraction blocks. Each block takes one input and applies, for example, two 3×3 convolutions +nonlinearity followed by a 2×2 max pooling. The number of kernels or feature maps may double after each block, allowing the architecture to learn complex structures effectively. The bottom layer mediates between the contraction layer and the expansion layer. For example, it uses two 3×3 CNN layers followed by a 2×2 upsampling layer. Similar to the contraction layer, the expansion layer may also consist of several expansion blocks. Each block forwards the input to two 3×3 CNN layers, followed by a 2×2 upsampling layer. Here too, the number of feature cards used by an upsampling layer is halved after each block in order to maintain symmetry. However, the input of the underlying layer is also extended by the feature maps of the corresponding contraction layer. This enables the neural network to obtain information directly from the contraction layer with the same resolution, so that high-frequency data does not have to be transmitted through the low-resolution bottleneck section at the bottom. The number of expansion blocks is the same as the number of contraction blocks. Finally, the resulting high-resolution feature map is projected down to the required output dimension using another convolutional layer. In one embodiment, the neural network contains predefined blocks for all contraction and expansion layers, referred to as “encoder” and “decoder” layers. These may be strung together to achieve the desired network depth. The parameters of the network architecture of the NN (number and type of layers, size of feature maps, interconnectivity) may be easily changed using a configuration structure to enable rapid experimentation.

In one embodiment, in order to identify and determine the position and orientation of the plurality of objects located in the observed area, for example the plurality of objects located on the top side of the observed area of the object cluster, an object coordinate map of the observed area of the object cluster and a segmentation mask of the observed area of the object cluster are determined (i.e. predicted) from the elevation map of the object cluster using the NN algorithm, wherein the object coordinate map illustrates the position of the respective pixel in object coordinates of the respective object and the segmentation mask contains for each pixel information about the association of the pixel with one segment of a plurality of segments and object boundaries, respectively. As shown above, the NN algorithm includes training on an elevation map and, in this embodiment, uses its pattern recognition capability to generate a new image (the object coordinate map) in which the object instances may, for example, be colored to represent correspondences to the data model of the respective object type (e.g., 3D CAD model of the respective object type). A transformation may be used to assign the coloring of the predicted object coordinate map to object coordinates of the coordinate system of the respective object. Such a transformation is based on the assumption used in the training of the respective NN algorithm that each point on the surface of the object's data model corresponds to a unique color value that results from the color value present at the same position within an RGB cube (see color coding of the data model described below). For the segmentation mask, the NN algorithm works by predicting the boundaries of the objects present in the observed area from the elevation map and storing them as a segmentation mask in an image with corresponding gray values. For example, the boundaries of every visible object, such as every object visible from above, are displayed in dark gray values and areas without objects are displayed in light gray values and white, respectively.

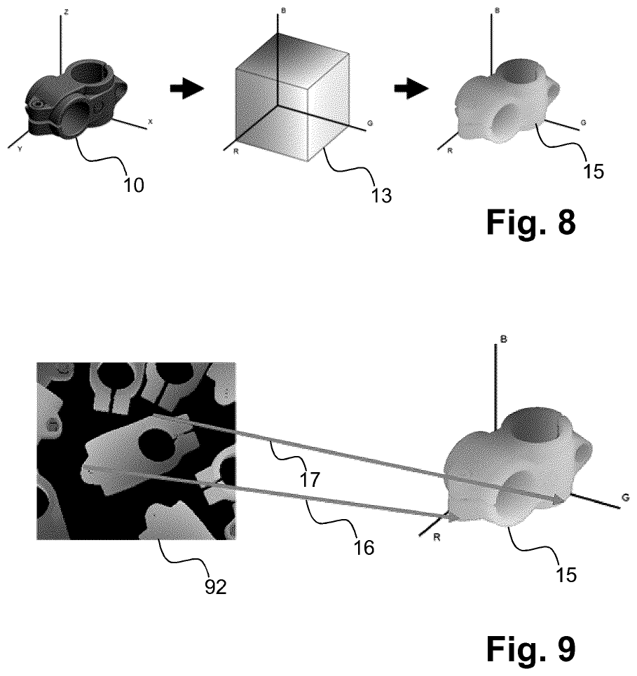

The color coding of the object's data model (see FIG. 8a) for the object coordinate map may, as mentioned above, be defined in such a way that each surface point of the data model of the respective object type is assigned a unique color. For example, a simple RGB cube-based color scheme may be used. First, a transformation is calculated to map the oriented bounding box of the data model (FIG. 8a) to the area [0-255, 0-255, 0-255] so that it fits exactly into the RGB cube shown in FIG. 8 b. For example, the main axis of the (centered) object type data model may be used to derive the rotation part. Scaling and displacement can then be easily calculated. With this transformation, each surface point of the object data model of an object type may be transformed into the RGB cube, and the corresponding color is used to color the surface point. Each surface point of the data model of the respective object type is therefore assigned a unique color, wherein the color uniquely embodies the position of the surface point in 3D (see FIG. 9).

In one embodiment, the segmentation mask is applied to the object coordinate map, individual objects are identified by means of this application as being located in the observed area, e.g. identified as lying on the top side of the observed area of the object cluster, and pixels of the object coordinate map and the elevation map belonging to the corresponding object are determined, wherein from this for each pixel belonging to an identified object the 3-dimensional coordinates in a predetermined coordinate system and the 3-dimensional coordinates in the coordinate system of the respective object are determined, and the 3-dimensional position and orientation of these identified objects in the predetermined coordinate system are determined from the coordinate pairs of all pixels of the respective identified object determined in this way.

For the above procedure, in one embodiment a binary mask is first generated from the segmentation mask, which highlights the boundaries of segments in the mask with the help of predetermined threshold values. In particular, a pixel number located in the segment is calculated for each segment formed by a circumferential boundary of the segmentation mask, i.e. for each contiguous structure, which generally corresponds to one object in each case. Segments with a pixel number that is below a specified pixel threshold are not taken into account in the subsequent further analysis. It is assumed here that the objects are largely covered. Segments with a pixel count equal to or above the pixel threshold are referred to as recognized segments and correspond to an object.

In this embodiment, the segmentation of the segmentation mask thus processed may then be transferred to the elevation map and the object coordinate map. In this embodiment, 3-dimensional coordinates in the predetermined coordinate system of the 3D scanner can also be assigned to each pixel of the elevation map of each segment. From the object coordinate map determined by the NN algorithm, each pixel of a segment can also be assigned a 3-dimensional coordinate in the coordinate system of the object corresponding to the respective segment on the basis of the transformation matrix of the color values of the data model used in training the NN algorithm, so that the result for each pixel of each detected segment is a coordinate pair consisting of 3-dimensional coordinates in a predetermined coordinate system (e.g. of the 3D scanner) and 3-dimensional coordinates in the coordinate system of the object corresponding to the respective segment. The coordinate pairs thus determined for each detected segment can be collected in a list, which may contain outliers due to imperfect prediction of the segmentation mask and/or object coordinate map. To rectify this situation, in one embodiment, a GPU RANSAC algorithm may be used to find a transformation in terms of position and orientation (pose) of the respective object type that causes most of the coordinate pairs to match. It has been found that the predictions of the NN algorithm are generally quite good and only a small number of outliers are to be expected. The use of robust estimation methods such as RANSAC in the embodiment also helps to improve the results of the NN algorithm in difficult situations. The RANSAC algorithm is a known resampling algorithm for estimating a model within a set of measured values with outliers and gross errors. Alternatively, so-called M-estimators may also be used. The coarse pose provided by the RANSAC algorithm may then be re-estimated in terms of weighted least squares using all outlier pixels with an orthogonal Procrustes algorithm based on the singular value decomposition of the 3×3 cross covariance matrix of the centered points. The estimated poses of the recognized segments, each corresponding to an object, are also called candidate poses. The orthogonal Procrustes algorithm may register two point clouds with known correspondences.

In one embodiment, the segmentation mask for each pixel may additionally contain the information on the level of the prediction reliability in relation to the position of the pixel in object coordinates. The fact that the NN algorithm also predicts the prediction reliability information for the pixels of the object coordinates is also taken into account and trained in this embodiment when training the NN algorithm. This is described in more detail below. This prediction reliability may be used as a weight in the above described re-estimation of the pose using the ortogonal Procrustes algorithm to determine candidate poses in a predetermined coordinate system (e.g., in the coordinate system of the 3D scanner).

In one embodiment, the candidate poses of the recognized segments may be further refined in a post-processing step and refined poses may be determined using an iterative closest point (ICP) algorithm on the GPU of the data processing unit, e.g. in the coordinate system of the 3D scanner. During the ICP, coordinate correspondences determined using the above method are discarded in each segment and new correspondences are calculated dynamically for each iteration of the algorithm in order to further improve the result. This takes advantage of the fact that an elevation map is available for the observed area, which enables fast calculation of the corresponding coordinates by projection along the view rays. The (projective) distance error of these dynamic correspondences may be minimized using a Levenberg-Marquard algorithm. The estimation of outliers is performed with Tukey weighting within the least squares solver. After ICP refinement, the correspondences are evaluated a second time to calculate the registration rms score and the proportion of covered pixels for each object/segment. The registration rms score is a quality measure for the registration, i.e. the remaining residual error between the data model of the respective object type and the determined point cloud.

These refined poses (position and orientation in a predetermined coordinate system) of the identified objects (segments) may then be provided at an interface of the data processing unit for transmission to a control element of a movable gripping and/or transport element or a movable robot element and used by the latter to control the movement of the gripping and/or transport element or the robot element.

In one embodiment, the elevation map of the observed area of the object cluster is determined by means of a 3D scanner and transmitted to the data processing unit. 3D scanners are systems using the cameras which capture the observed area from at least two angles and determine the elevation map of the observed area of the object cluster from the image data thus obtained. This determination of the elevation map may be repeated at predetermined time points in predetermined time intervals (e.g. every minute or every second or every tenth of a second) and/or depending on the progress of the removal or manipulation of the objects from the cluster (e.g. after the removal of 5 objects), the movement of the objects and/or depending on the occurrence of further events (e.g. the filling of the container with further objects, signal of a monitoring device, e.g. a light barrier) and transmitted to the data processing unit accordingly. In this way, the determination of the position and orientation of removable objects and, accordingly, the work of a gripping and/or transport element or robot element may be adapted continuously or when required to the changing conditions of the object cluster.

In one embodiment, the method is configured to localize objects moving in the observed area, in which the elevation map of the observed area of the object cluster is received at one predetermined time points or several predetermined time points, the plurality of objects arranged in the observed area is identified and their 3-dimensional position and orientation is determined and provided at the interface of the data processing unit. This method is used for line tracking or visual servoing. The objects in the object cluster move along a conveyor belt, for example. In this case, the object cluster represents, for example, a plurality of objects arranged one above the other and/or adjacently, for example a series of objects of one or more object types arranged one after the other on a conveyor belt. The visible objects of the object cluster are identified at a predetermined point(s) in time (this also includes a predetermined time sequence with equal or unequal intervals between the points in time, for example every tenth of a second or every second) and the 3-dimensional position and orientation of the objects are determined as described above. The time interval between the points in time may be predetermined or may be changed based on the movement of the objects (for example, the time interval between the points in time may be shortened if the speed of the movement of the objects increases or, conversely, the time interval between the points in time may be prolonged if the speed of the movement of the objects decreases). Accordingly, the 3-dimensional position and orientation of the objects as well as the information about the identified objects is also provided at the interface of the data processing unit at the specified point(s) in time.

In one embodiment, the predetermined time point(s) may be determined by means of a monitoring device, for example a light barrier and/or by means of a scale integrated into a substructure of a conveyor belt and/or by means of camera monitoring. The monitoring device detects the time point of a predetermined position of an object along its movement. Based on the point in time detected by the monitoring device, in this embodiment one or more points in time are specified for the determination, e.g. by means of a 3D scanner, transmission and corresponding receipt of the elevation map of the observed area. At the respective time point of determination of the elevation map, at least one object of the object cluster generally exists in the observed area (field of view). Accordingly, the elevation map of the observed area of the object cluster is determined, transmitted and received at one predetermined time point or several predetermined time points. As a result, the determination of the 3-dimensional position and orientation of the objects arranged in the observed area is synchronized with the movement of the objects, which improves the accuracy of the data on the 3-dimensional position and orientation of the object provided at the interface of the data processing unit in the case of moving objects.

Analogous to the method described above, the above object is solved by a device for automatically locating of objects from an observed area of an object cluster consisting of a plurality of objects of at least one object type arranged adjacently and/or one above the other with a data processing unit which is configured to
Receive a data model of the at least one object type,
Receive an NN algorithm trained for the specific at least one object type, wherein the NN algorithm is trained based on the data model of the at least one object type,
Receive an elevation map of the observed area of the object cluster,
Identify a plurality of objects located on the top side of the object cluster in the observed area of the object cluster and determining the 3-dimensional position and orientation of said plurality of objects in a predetermined coordinate system based on the NN algorithm trained with respect to the at least one object type using the data model of the at least one object type and using exclusively the elevation map of the observed area of the object cluster with respect to the observed area, and
Provide the 3-dimensional position and orientation of the plurality of objects arranged on the top side of the object cluster in the observed area of the object cluster at an interface of the data processing unit.

In one embodiment, a device for automatically locating of objects suitable for removal from an observed area of an object cluster present in an open container, consisting of a plurality of objects of at least one object type lying on top of one another, is implemented with a data processing unit which is configured to
Receive a data model of the at least one object type,
Receive an NN algorithm trained for the specific at least one object type, wherein the NN algorithm is trained based on the data model of the at least one object type,
Receive an elevation map of the observed area of the object cluster,
Identify a plurality of objects lying on the top side of the observed area of the object cluster, and determining the 3-dimensional position and orientation of said plurality of objects lying on the top side of the object cluster in a predetermined coordinate system by means of a data processing unit based on the NN algorithm trained with respect to the at least one object type using the data model of the at least one object type and using exclusively the elevation map of the observed area of the object cluster with respect to the observed area, and
Provide the 3-dimensional position and orientation of the plurality of objects lying on the top side of the observed area of the object cluster at an interface of the data processing unit.

Analogous to the above method, the devices may be configured to additionally receive a data model of a container, use an NN algorithm additionally trained on the data model of the container and identify a plurality of objects located in the observed area of the object cluster, for example objects located on the top side of the observed area of the object cluster, and provide the 3-dimensional position and orientation of the plurality of objects located on the top side of the observed area of the object cluster to an interface of the data processing unit, and determines the 3-dimensional position and orientation of this plurality of objects in a predetermined coordinate system by means of a data processing unit additionally based on the NN algorithm trained in relation to the at least one container using exclusively the elevation map of the observed area of the object cluster and the data model of the at least one object type.

The advantages of the above devices, each comprising a data processing unit, may be inferred from the above description of the corresponding method. The devices also comprise a memory unit in which at least the data relating to the data model of the at least one object type and, if applicable, the container and the NN algorithm may be stored.

In one embodiment, the data processing unit is configured to identify and determine the position and orientation of the plurality of objects arranged in the observed area of the object cluster, for example the objects located on the top side of the observed area of the object cluster, exclusively an object coordinate map of the object cluster and a segmentation mask of the object cluster are determined from the elevation map of the object cluster by means of the NN algorithm trained on the at least one object type and the container, wherein the object coordinate map illustrates the position of pixels in object coordinates and the segmentation mask illustrates for each pixel information about the association of the pixel with one segment of a plurality of segments.

In one embodiment, the data processing unit is configured to apply the segmentation mask to the object coordinate map, use the application to identify individual objects as being located in the observed area of the object cluster, for example lying on the top side of the observed area of the object cluster, and determine pixels of the object coordinate map and the elevation map belonging to the corresponding object, wherein it determines from this the 3-dimensional coordinates in a superior coordinate system and the 3-dimensional coordinates in the coordinate system of the respective object for each pixel belonging to an identified object, and determines the 3-dimensional position and orientation of these identified objects in the predetermined coordinate system from the coordinate pairs of all pixels of the respective identified object determined in this way.

In one embodiment, the segmentation mask for each pixel also contains information on the level of the prediction reliability in relation to the position of the pixel in object coordinates.

In one embodiment, the device additionally comprises a 3D scanner that determines the elevation map of the observed area of the cluster and transmits it to the data processing unit. For this purpose, the 3D scanner comprises at least two cameras that look at the observed area of the object cluster from different viewing directions. Each camera is configured, for example, as a digital camera, e.g. a matrix camera, whose position and orientation in space is known. The position and orientation of each camera may be determined with a calibration. The 3D scanner may determine the elevation map from the recordings of the at least two cameras of the surface of the object cluster.

In one embodiment, the device is configured to localize objects moving in the observed area, wherein the device is configured to repeatedly receive the elevation map of the observed area of the object cluster at one predetermined time point or at several predetermined time points, to identify the plurality of objects arranged in the observed area and to determine their 3-dimensional position and orientation and to make them available at the interface of the data processing unit. This device is particularly suitable for line tracking or visual servoing.

The embodiments explained above in connection with the localization method are also used analogously in a device according to the invention.

The above object is further solved by a system for controlling a movable gripping and/or transport element for removing an object from an observed area of an object cluster present in an open container consisting of a plurality of superimposed objects of at least one object type (bin-picking), wherein the system comprises a device described above and a control device, wherein the data processing unit of the device transmits the 3-dimensional position and orientation of the objects lying on the top side of the observed area of the object cluster to the control device, wherein the control device determines corresponding control signals for the movement of the gripping and/or transporting element for removing the corresponding object from the container from the transmitted 3-dimensional position and orientation of the objects, at least for a subset of the objects lying on the top side, and moves the gripping and/or transporting element in accordance with the determined control signals.

Furthermore, the above object is solved by a line-tracking system for controlling a movable gripping and/or transporting element for manipulating an object from an object cluster consisting of a plurality of objects of at least one object type arranged one above the other and/or adjacently, wherein the system comprises a device described above for locating objects moving in the observed area and a control device, wherein a data processing unit of the device is configured to transmit the 3-dimensional position and orientation of the objects arranged in the observed area of the object cluster to the control device of the gripping and/or transport element, wherein the control device is configured to calculate the position and orientation of the objects from the transmitted 3-dimensional position and orientation of the objects at least for a subset of the objects, e.g. one object, two objects or three objects, wherein the object/objects generally represent the object/objects that are best trackable or easiest to manipulate, to determine corresponding control signals for the movement of the gripping and/or transport element for manipulating the corresponding object and to move the gripping and/or transport element in accordance with the determined control signals. The manipulation may include a predetermined movement of the gripping and/or transport element, which is performed after a predetermined start state. After completion of the movement, the respective object has reached an end state and the system identifies a new object in the observed area for removal, manipulation and/or relative movement of the robotic element or gripping and/or transport element after the next elevation map of the observed area has been received.

For example, the gripper and/or transport element manipulates the localized object of the object cluster in such a way that it grips the object (start state) and then performs the predefined movement, namely lifts the object from a first conveyor belt, transports it to a second conveyor belt and places it on the second conveyor belt at a predefined distance from the previous object. For this purpose, the gripping and/or transport element comprises, for example, a gripping hand, suction foot, two-jaw gripper, clamping gripper, magnetic gripper or similar. Further manipulations may include, for example, mounting a component in and/or on the object, inspecting the object or a predetermined section of the object, transporting the object into a disposal container or on a disposal conveyor belt, painting the object or a predetermined section of the object or joining a component to the object by means of a joining element.

Likewise, the above object is solved by a visual servoing system for controlling a robot element moving in such a way that it takes a predetermined position relative to an object from an object cluster consisting of a plurality of objects of at least one object type arranged one above the other and/or adjacently, wherein the system comprises a device described above for locating objects moving in the observed area and a control device, wherein a data processing unit of the device is configured to transmit the 3-dimensional position and orientation of the objects arranged in the observed area of the object cluster to the control device of the robot element, wherein the control device is configured to determine from the transmitted 3-dimensional position and orientation of the objects, at least for a subset of the objects, corresponding control signals for the movement of the robot element to take the predetermined position relative to the object corresponding to and to move the robot element in accordance with the determined control signals, wherein the predetermined position comprises a plurality of positions to be taken successively in a predetermined sequence (i.e. a movement of the robot element). In the latter case, when all positions have been run through, this system also reaches a final state with regard to the respective object.

In this case, a predetermined position relative to the object

The above object is further solved by a method for automatically training an NN algorithm for identifying and locating objects from an observed area of an object cluster, for example objects suitable for removal from an observed area of an object cluster present in an open container, by means of a data processing unit with the following steps:
a) Using a physical model for arranging a predetermined number of objects of at least one object type, each of which corresponds to the data model of this object type, in a container in such a way that a ground truth object cluster is created from the predetermined number of objects,
b) Rendering an ideal elevation map of the observed area of the object cluster based on the ground truth object cluster,
c) Rendering an ideal object coordinate map of the observed area of object clustering based on the ground truth object clustering,
d) Rendering an ideal segmentation mask of the observed area of object clustering based on the ground truth object clustering,
e) Modifying the ideal elevation map using a first modification function to produce a training elevation map,
f) Determining a predicted object coordinate map and a predicted segmentation mask from the training elevation map using the current version of the NN algorithm for the observed area of object clustering,
g) Determining a loss using a loss function from a comparison of the predicted object coordinate map with the ideal object coordinate map and from a comparison of the predicted segmentation mask with the ideal segmentation mask,
h) Modifying the NN algorithm to minimize the value of the loss function,
i) Repeating steps e) to h) with different modification functions which differ from the first modification function, and/or steps a) to h) with different numbers of objects of the same at least one object type and/or different orientations of the container and/or different observation areas of the container until a termination criterion is reached,
j) Storing the last version of the trained NN algorithm in a data memory of the data processing unit.

In one embodiment of the training method and localization method, respectively, the NN algorithm is based on a U-Net architecture.

The above method is also usually realized as a computer-implemented method by means of a data processing unit (e.g. a computer), which has a processor and a computer-readable memory unit.

In one embodiment, to generate training elevation maps, the ideal elevation map may be modified using a first modification function such that a training elevation map is created. For example, the modification function may include cropping, mirroring, scaling, brightness change, color increase, saturation change, contrast change, shift and/or rotation. Additionally or alternatively, noise and/or artifacts may be generated in the ideal elevation map that correspond to those of real data. For example, points in the ideal elevation map with a normal vector greater than a randomly determined threshold may be removed from the elevation map. This example is similar to the behavior of 3D scanners, which capture surface points with a large angle incorrectly, as the light is reflected away from the camera. This is particularly relevant for highly reflective materials. In another example of simulating real data as training elevation maps, the finding that the measurement noise level in a 3D scanner is reduced as the number of cameras increases that can see a point may be used. This behavior may be modeled in the training elevation maps for the NN algorithm by evaluating the visibility image of the cameras, removing all points with a visibility number less than two, and creating a map of noise level that decreases in its height for higher visibility numbers. In another example of adapting the training elevation maps to real effects, it is simulated that the measurement noise often correlates between neighboring pixels of the elevation map. To create corresponding training elevation maps, a multiscale noise (similar to Perlin noise) with a predefined spectrum is added to the elevation values and the amplitude is modulated by the previously created noise level map. In another example, it may be simulated that highly specular reflections occasionally cause small areas of the elevation map to have erroneous values. Therefore, small pixel islands (approx. 1-100 pixels) with random elevation per island are added to the ideal elevation map using the modification function to make the NN algorithm robust against such artifacts. Additionally or alternatively, defined resolution and suboptimal camera sharpness lead to slightly blurred elevation images. To train this in training elevation maps, a bilateral Gaussian filter with random sigma is used when creating a training elevation map to smooth the elevation in homogeneous regions but prevent blurring at large elevation differences. In another example of simulating real elevation maps for training the NN algorithm, randomly determined rotated rectangles are deleted from the ideal elevation map (i.e. they appear all black or all white and are also referred to as blackout). This change in the data does not correspond to any real effect when capturing the elevation map, e.g. using a 3D scanner. However, it serves two important purposes: first, a CAD model created from 3D scans may comprise imperfections that are not present in the real objects and that could help the detector to resolve symmetries or difficult poses. Such regions are occasionally overdrawn by the blackout, so that the NN algorithm may not rely exclusively on these features. Second, the blackout is only applied to the training elevation map, but not to the ideal object coordinate map, forcing the NN algorithm to complete these regions from context only. This helps to determine robust and generally usable parameters of the NN algorithm.

In one embodiment of the training method, symmetry that may exist for an object type is taken into account when determining the loss using the loss function, wherein the loss is determined as the loss of the loss function for which the object coordinate map loss function proportion is minimal for different positions of the respective object with regard to the symmetry. For this purpose, it must be determined in advance when creating the data model of the at least one object type whether and, if so, which symmetry axis(es) the data model comprises. Each possible position of the respective object means a different appearance in the object coordinate map.

In one embodiment of the training method, when determining the loss using the loss function, the pixels of the object boundaries of the predicted segmentation mask are weighted more heavily than the other pixels by means of multiplication with a mask weight function. Such a function is explained in more detail below. This gives the boundary pixels of an object a greater influence on the overall loss function, which favors correct prediction of the boundary areas of an object in the segmentation mask and avoids segmentation errors. The result is normalized with respect to the number of pixels in the segmentation mask. The mask weight function may, for example, be calculated from a modification of the ideal segmentation mask of the observed area, in which each object and in particular the respective pixels of the object are assigned a unique scalar value (an ID, object ID map).

In one embodiment of the training method, the predicted segmentation mask for each pixel additionally includes prediction confidence information derived from the object coordinate map loss function proportion of the loss function. As will be described in detail below, such an embodiment has been found to be advantageous in which a prediction confidence of the object coordinate map pixels is included in the training process. The prediction reliability information may, for example, be stored in a proportion of the information associated with each pixel of the segmentation mask. For example, information relating to the segmentation of the mask may be stored in a range of values [0.0; 0.5[(i.e. 0.5 excluded), and information relating to the prediction confidence may be stored in a range of values [0.5; 1.0]. For example, the prediction confidence for the respective pixel may be directly derived from a difference amount of the ideal object coordinate map and the object coordinate map predicted for the respective training elevation map.

The data processing unit for identifying the removable objects and their position and orientation and for training the NN algorithm comprises a processor, which is a functional module that interprets and executes instructions/commands of algorithms and comprises an instruction control unit as well as an arithmetic unit and a logic unit. The processor may comprise at least a microprocessor, a digital signal processor (DSP), an application specific integrated circuit (ASIC), a field programmable gate array (FPGA—digital technology integrated circuit into which a logic circuit can be programmed), a discrete logic circuit and any combination of these devices. The data processing unit may also comprise a memory unit, an input module (e.g. keyboard or touchpad), a power supply module (e.g. battery) and a display module (e.g. display). The data processing unit may be configured as a real hardware resource, for example a smartphone, desktop computer, server, notebook, cluster/warehouse scale computer, embedded system or the like, or as a virtualized computer resource. Furthermore, the data processing unit may comprise a transmitter/receiver (transceiver) for exchanging data with the 3D scanner. The data processing unit also comprises an interface for exchanging data with the control element of the gripping and/or transport element.

As already explained above, the methods explained above may each be implemented, for example be realized as a computer program or computer-implemented method comprising instructions which, when executed, cause a processor of the data processing unit to perform the steps of the above method, wherein the computer program contains a combination of the steps and data definitions described above which enable the computer hardware to perform computing or control functions, and/or which is a syntactic unit which conforms to the rules of a particular programming language and which consists of declarations and statements or instructions required for the functions, tasks or problem solutions explained above.

Further disclosed is a computer program product comprising instructions which, when executed by the processor of the data processing unit, cause the device to perform the steps of any or all of the procedures defined above. Accordingly, a computer readable medium storing such a computer program product is disclosed. The computer program product may be a software routine.

Further advantages, features and possible applications of the present invention will also be apparent from the following description of embodiments and the drawings. All the features described and/or illustrated form the object of the invention, either individually or in any combination, even independently of their summary in the claims or their references.

Schematically show:

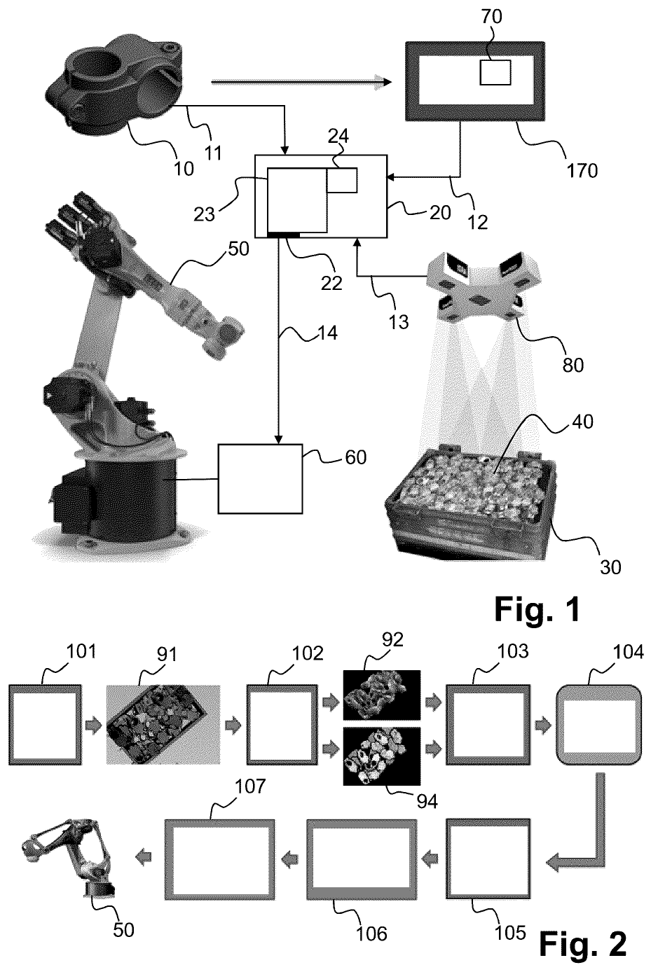

FIG. 1 a schematic of an embodiment of a device according to the invention for automatically locating objects suitable for removal from an observed area of an object cluster present in an open container, and of an embodiment of a system for controlling a gripping and/or transport element for removing an object from the observed area of an object cluster present in the open container, consisting of the plurality of objects of at least one object type lying on top of one another, respectively,

FIG. 2 a flow chart of an embodiment of a method according to the invention for automatically locating of objects suitable for removal from an observed area of an object cluster present in an open container consisting of a plurality of objects of at least one object type lying on top of one another,

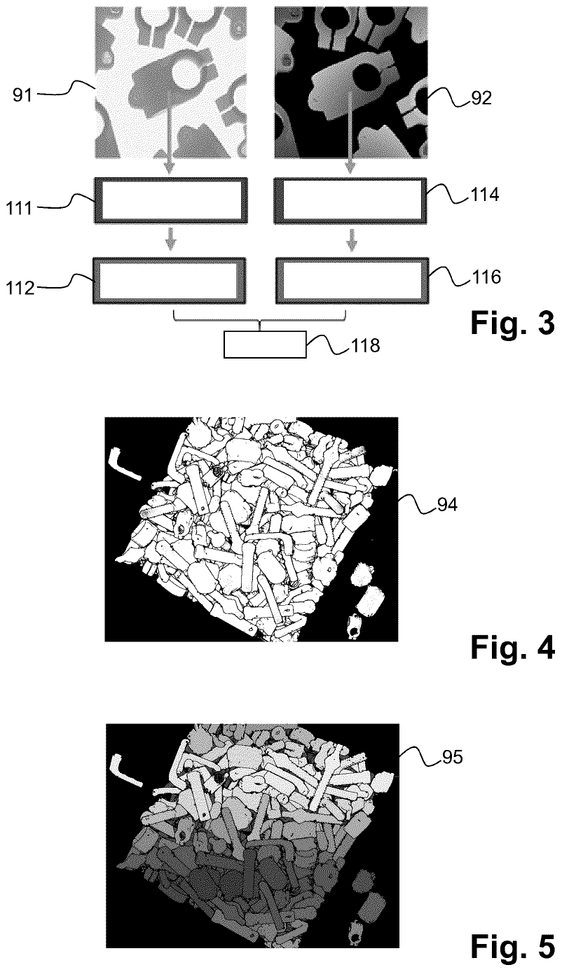

FIG. 3 a flow chart of a section of the method according to FIG. 2,

FIGS. 4, 5 an example segmentation mask and processing of the segmentation mask used in the method according to FIG. 2,

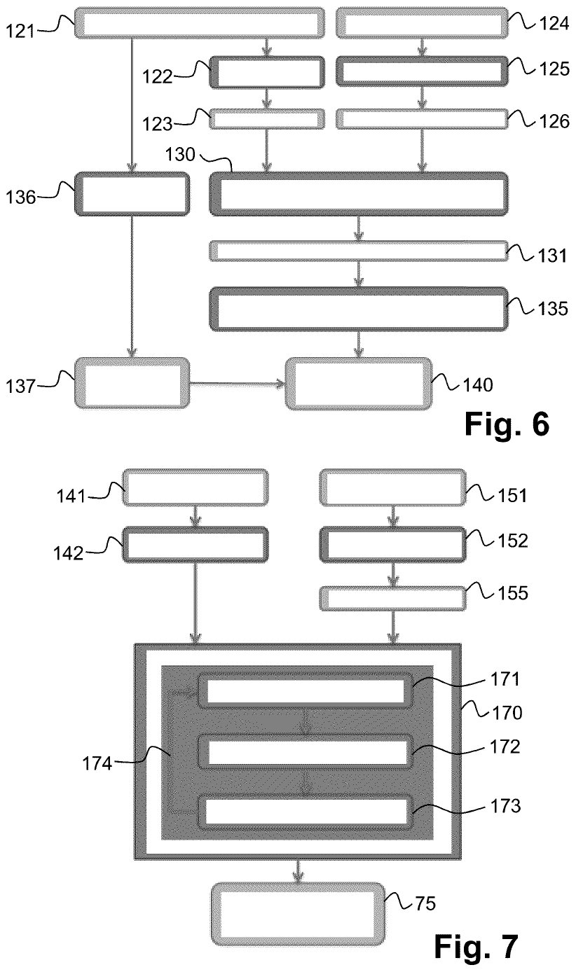

FIG. 6 a flow chart of an embodiment of the generation of training data for a method for the automatic training of an NN algorithm for the identification and locating of objects suitable for removal from an observed area of an object cluster present in an open container,

FIG. 7 a flow chart of an embodiment of a method for automatically training an NN algorithm for identifying and locating objects suitable for removal from an observed area of an object cluster present in an open container, in which the training data of the method according to FIG. 6 may be used,

FIGS. 8,9 an embodiment of the creation of a data model for an object type for a method according to FIG. 2 and FIG. 7, respectively, using image data and perspective side views, respectively,

FIG. 10-12 an embodiment of the creation of a data model of the container for a method according to FIG. 2 and FIG. 7, respectively, using image data and perspective side views, respectively,

FIG. 13-16 perspective side views of examples of objects with and without symmetry axes,

FIG. 17 ran example of the operation of a physical model for the method shown in FIG. 7,

FIG. 18 a perspective side view of an example of a ground truth object cluster in a container and in a random environment for the training method according to FIG. 7,

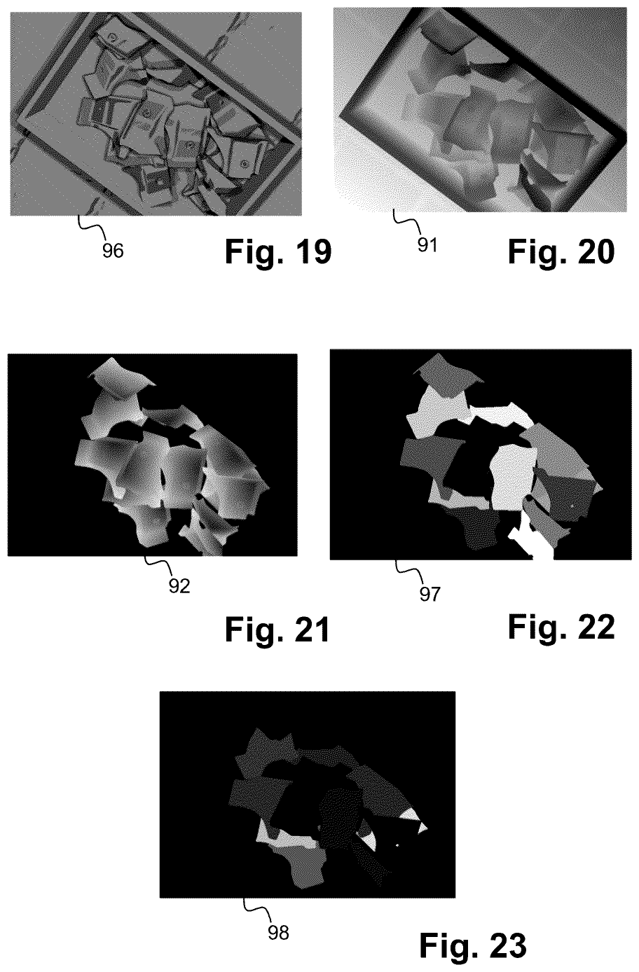

FIG. 19 an example of an image of the camera visibility rendered from the ground truth object cluster according to FIG. 18 for an observed area,

FIG. 20 an example of an ideal elevation map rendered from the ground truth object cluster according to FIG. 18 for an observed area,

FIG. 21 an example of an ideal object coordinate map rendered from the ground truth object cluster according to FIG. 18 for an observed area,

FIG. 22 an example of an ideal object ID map rendered from the ground truth object cluster according to FIG. 18 for an observed area,

FIG. 23 an example of an ideal map rendered from the ground truth object cluster according to FIG. 18 for an observed area, showing the uncovered proportion of each object,

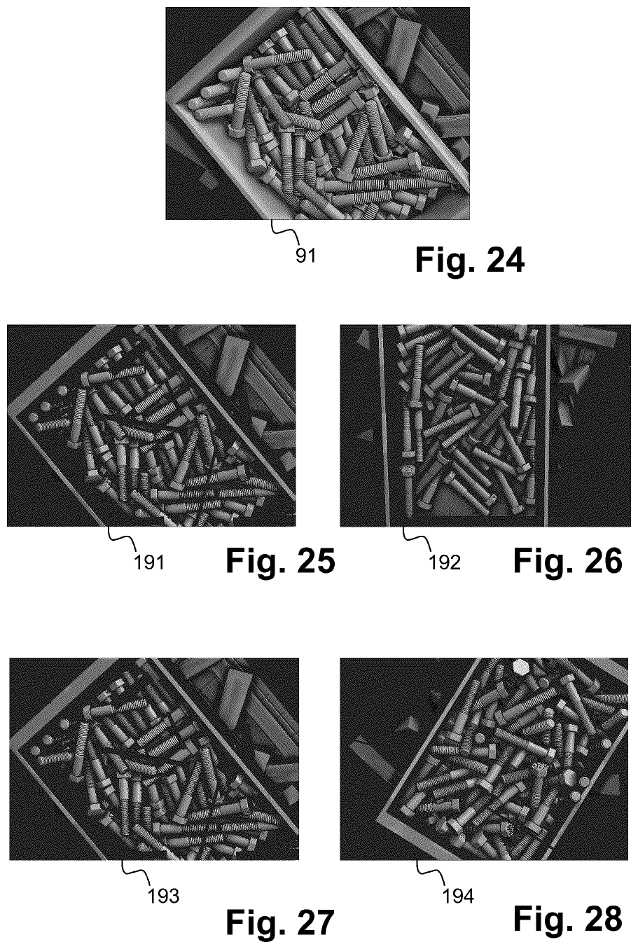

FIG. 24 another example of an ideal elevation map rendered from a ground truth object cluster for an observed area,

FIG. 25-28 examples of training elevation maps for the method according to FIG. 7, which were generated from the ideal elevation map according to FIG. 24,

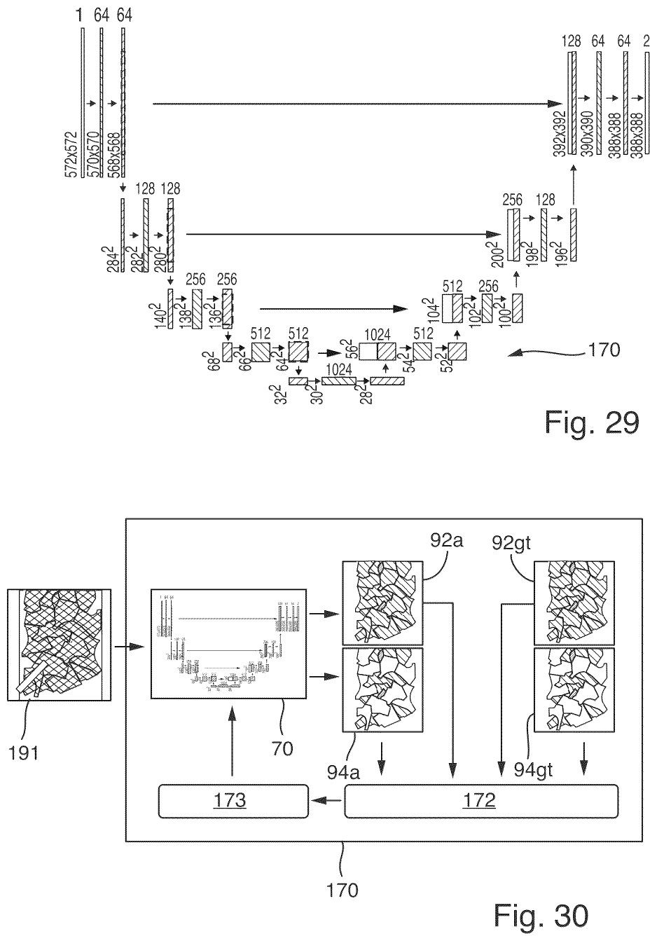

FIG. 29 an example of an nn algorithm for the method according to FIGS. 1, 2 and 7,

FIG. 30-31 flow charts of examples of the determination of the loss by means of a loss function and of the corresponding adaptation of the NN algorithm of the method according to FIG. 7,

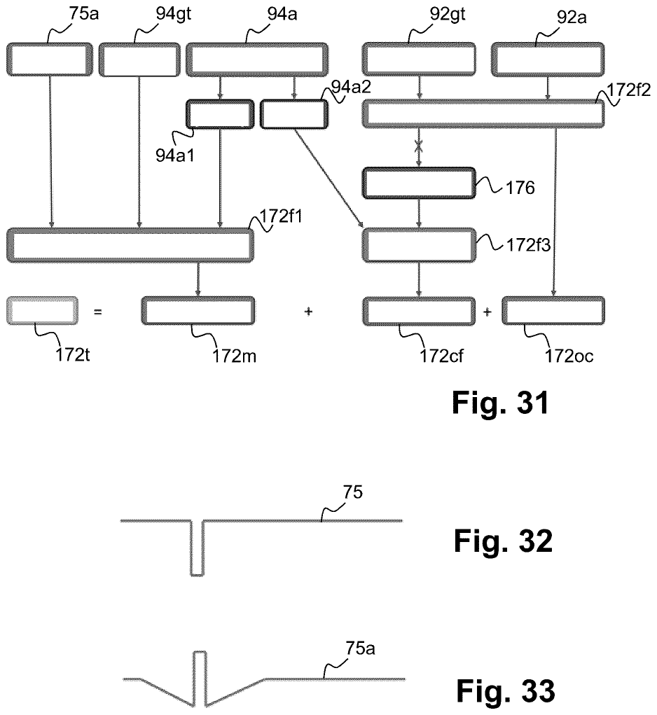

FIG. 32-33 examples of the course of the boundary of a binary mask and of a mask weighting function, respectively, to determine the loss function according to FIGS. 30 and 31, respectively, and

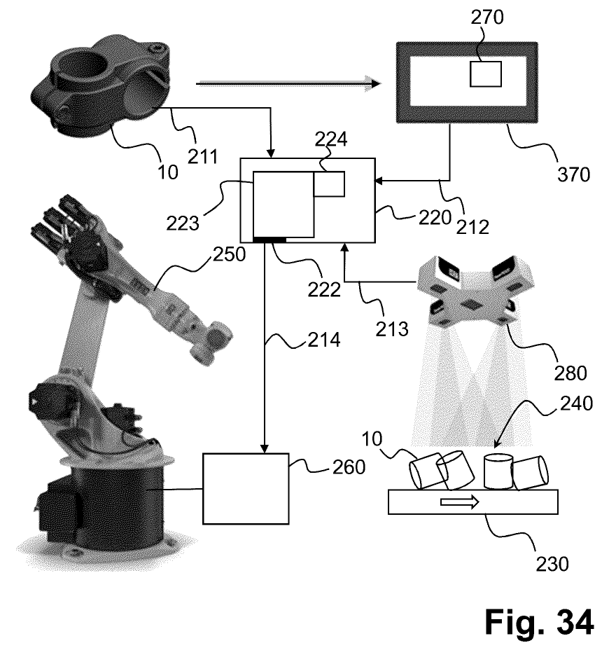

FIG. 34 a further embodiment of a device for automatically locating objects from an observed area of an object cluster and an embodiment of a system for controlling a gripping and/or transporting element for manipulating an object or a robot element for positioning the robot element relative to the object of the observed area of an object cluster consisting of the plurality of objects of at least one object type lying one above the other or adjacently, respectively.

In the figures explained below, color representations used in reality are reproduced in gray scale (i.e. gray scale between white and black). The skilled person is familiar with the fact that, particularly where this is expressly indicated, different colors correspond to the different shades of gray.

FIG. 1 shows an object 10 and a device 20 for automatically locating such objects 10 from an observed area of an object cluster 40 present in an open container 30. When objects 10 suitable for removal have been identified in the object cluster 40 and their position and orientation (pose) have been determined by the device 20, the data on the position and orientation of the objects 10 may be transmitted by means of a corresponding interface 22 of the device to a gripping and/or transport element 50, for example a robot end effector, with a control device 60. The control device 60 further processes the transmitted position and orientation data of the objects 10 identified for removal from the container 30 and determines movement trajectories for the gripping and/or transporting element 50. If the gripping and/or transporting element 50 moves along these trajectories, the gripping and/or transporting element may remove identified objects 10 individually from the container 30 and transport them to a predetermined position, for example a conveyor belt or a machine for further processing of the object 10. The object cluster 40 is located in the container 30 and consists of a plurality of objects 10 lying on top of each other in a random or ordered arrangement. In the embodiment shown in FIG. 1, only a single object type is included as object 10 in the object cluster 40, namely the component shown at the top left in FIG. 1. However, different object types may also be used in the object cluster 40, wherein no object, one object or several objects of each object type may be present in the object cluster 40.

For automatically locating of objects 10 suitable for removal in the object cluster, a data model (CAD model) of the object 10 is transmitted to the device 20 (see arrow 11). The CAD model is also used to train an NN algorithm 70 by means of a corresponding training device 170, which is also transmitted to the device 20 after completion of the training (see arrow 12). The system also provides a 3D scanner 80 using the cameras which look at the surface of the object cluster 40 in the container 30 from different viewing directions. The 3D scanner generates an elevation map 91 of an observed section of the current object cluster 40 as it is currently located in container 30. Examples of such an elevation map 91 can be found in FIGS. 2 and 3. This elevation map 91 is also transmitted to the device 20 (see arrow 13), which has a data processing unit 23 and a memory unit 24. The data processing unit 23 may be separate from the training device 170, as shown in FIG. 1, or the training device 170 may be integrated into the data processing unit 23. By means of the trained NN algorithm 70, which is stored in the memory unit 24, objects 10 are identified on the surface of the object cluster 40 and their position and orientation are determined. This is described in more detail below. This data is provided at an interface 22 and may be transmitted to the control device 60 for controlling the gripping and/or transporting element 50 for removing the identified objects, for example for controlling the translational and yaw, pitch and/or roll movement, respectively, of the gripping and/or transporting element (see arrow 14). The gripping and/or transport element (e.g. the end effector of a robot arm) is controlled in such a way that an identified object 10 is gripped and transported away from the container 30 to a conveyor belt. The object 10 is set down there in a predetermined position and fed by the conveyor belt for further processing.

With reference to FIG. 2, an embodiment of a method for automatically locating is described below. In a step 101, the 3D scanner 80 first generates an elevation map 91 of an observed area of the object cluster 40 from which objects 10 are to be removed. The elevation map 91 is transmitted to the device 20. Based on the transmitted elevation map, the NN algorithm 70 trained on the specific object 10 predicts an object coordinate map 92 and a segmentation mask 94 in step 102, which are further processed based on the known data models of the object 10 and the container 30 in step 103 by means of the data processing unit 23 (e.g. CPU/GPU). The further processing results in a plurality of identified objects and their position and orientation in a predetermined coordinate system (step 104). In a subsequently following step 105, this data may be further refined by means of a fast ICP (iterative closest point) algorithm, for example with the help of the GPU of the data processing unit 23, and matching evaluations and estimates of covering may be carried out therefore. As a result of this step, the data associated with the removable objects, their position and orientation and, if necessary, further data (evaluations, occlusion estimates) are provided at the interface 22. Such evaluation and estimation are important for the verification of the data and trajectory planning in the control device 60 that are subsequently carried out in steps 106 and 107, for example to decide in which order the identified objects are removed from the object cluster 40.

In the further processing step 103, a binary mask having highlighted object boundaries is generated from the segmentation mask 94 in the manner described above. An example of a predicted segmentation mask 94 for an object cluster with object types that are partially different from the object shown in FIG. 1 is shown in FIG. 4. FIG. 32 shows the development of values of the binary mask along a line in this mask, wherein the line intersects an object boundary that appears as a lowered step. The object boundary may be displayed in black in the mask. Contiguous/connected segments are determined from this. Segments comprising a number of pixels that is below a specified threshold value are discarded, i.e. they are not identified as objects. A resulting mask 95 showing connected segments, wherein each segment is assigned with a specific gray or color value, is shown in FIG. 5, wherein the mask of FIG. 5 was determined from the predicted segmentation mask 94. It is assumed that each identified connected segment corresponds to a single object in the object cluster.

Likewise, in the further processing step 103, as already described above, a 3D coordinate 112 in the coordinate system of the 3D scanner 80 is determined for each pixel of the elevation map 91 using the calibration of the 3D scanner 80. Furthermore, the corresponding 3D coordinate 116 in the object coordinate system is determined for each pixel from the predicted object coordinate map 92 by means of a transformation matrix 114, which assigns a coordinate in the object coordinate system to the color values, so that as a result a 3D coordinate pair 118 (consisting of the coordinates 112, 116) is assigned to each pixel of the elevation map 91. By means of the identified connected segments (see mask 95), the coordinate pairs 18 can be assigned to a segment. By means of the RANSAC algorithm already described above, the GPU of the data processing unit 23 and by means of the orthogonal Procrustes algorithm, the position and orientation (also referred to above as candidate poses) of identified objects in a predetermined coordinate system may be calculated from this data for each segment and object, respectively.

In the further step 105, the refinement of the determined candidate poses of the identified objects (segments) as already explained above is performed by the GPU of the data processing unit 23 using the ICP algorithm. Refined poses of the identified objects in the predetermined coordinate system are determined as result.

In the following, an embodiment for the training of the NN algorithm 70 is described, which is illustrated using the flowcharts of FIGS. 6 and 7. Here, FIG. 6 visualizes the automatic generation of training data for the training and FIG. 7 the training procedure. FIG. 31 also shows the determination of the loss function.

The creation of training data (see FIG. 6) includes the provision of a data model for the at least one object type (e.g. CAD model) in step 121. The data model is preprocessed, for example, by rescaling, transformation (step 122) and by color coding of the data model (see above and FIGS. 8, 9) of the object 10 using RGB cube 13 (in step 123). In contrast to the gray value representation in FIGS. 8, 9, the color coding 15 includes the corresponding RGB colors of the RGB cube 13, which correspond to the respective object coordinates on the surface of the object 10. The pre-processed data model of the at least one object type is transmitted to the physics simulation, which is represented by step 130 in FIG. 6.

The physics simulation 130 also receives data of a processed container data model in step 126 after providing the data model for the container 30 in step 124 and pre-processing the container data model in step 125. For example, the container data model is analyzed to find its wall and floor planes for the physics simulation. In addition, the size of the container is adjusted to the desired dimensions. This may also be performed for multiple container types together. For example, a plurality of standard container data models may be provided as a list, wherein an embodiment of a container 30 is shown in FIG. 10. The container data model may be randomly selected for each training example to make the NN algorithm robust to changes in container shape.

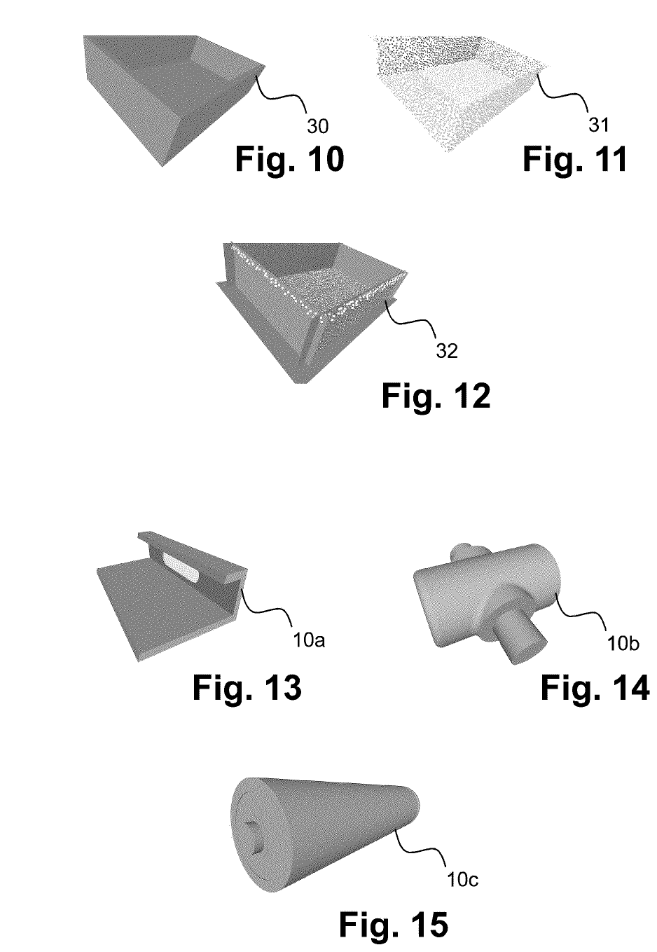

During the analysis of the container data model (see FIG. 10), a pixel cloud 31 is first formed from each container data model (see FIG. 11), which represents the surface of the container 30. The pixels are then assigned to the four walls and one bottom of the container, respectively, based on their position and their normal vectors. For each wall (and bottom) surface, a position range along the X, Y and Z directions is derived from the expansion of the bounding box. In addition, a normal angle range is defined by specifying a maximum angle between the pixel normal and the dominant wall direction (X-, Y-, Z-axis). The results of this mapping algorithm are visualized in FIG. 11 using different colors (shades of gray) of the walls and bottom, respectively. Subsequently, a robust iterative plane matching algorithm of the container is used to approximate the respective wall vertices by a plane by minimizing the squared error between all interior pixels and the plane (cf. container data model 32 shown in FIG. 12). This data model (possibly for a plurality of containers 30) is also transmitted to the physics simulation 130.

In the physics simulation in step 130, the preprocessed data models of the object types (here only a single object type 10) and of the container 30 are used to simulate a filling process of the container with virtual objects 10. Various simulation parameters (e.g. number of parts, friction, direction of gravity) may be randomized. The physics simulation is a software component for simulating an artificial environment for placing objects 10 in a container 30 (for example, pybullet may be used as a simulation library). As can be seen in FIG. 17, the objects 10 are created above a container 30 and then released to fall down. This procedure guarantees a random distribution of the objects 10 within the container 30. The arrangements of the objects within the container resulting from the physics simulation, which are created in step 131, are then rendered in step 135.

In the context of an embodiment of physics simulation, the positions and orientations in the generation of the objects above the container may be restricted and customized to cover applications where ordered filling is required. To this end, the user may specify a list of pose generators (more precisely, their parameters) along with a probability for the selection of each generator during the creation of the training example. The random selection of generators with the specified probabilities leads to diverse training data sets and thus to a more robust NN algorithm.

Overall, the physics simulation in an embodiment may be designed in such a way that it can be adapted to the object cluster to be trained. For example, it is possible to randomly determine the number of objects inside the container. In this case, a maximum number of objects may be calculated based on the container volume and the volume of the objects. For each training example, the number of objects may be randomly selected between 0 and the maximum value. In this way, different filling levels of the container are covered. It is also possible to control gravity and friction to control the packing of the sub-units in the container. For example, if the direction of gravity is inclined, all objects are pushed to a specific wall or corner of the container and packed tightly. These variations randomize the training data in order to obtain an NN algorithm that is trained as comprehensively as possible.

In the step 135, rendering is performed based on the arrangements of the objects in the container obtained by means of the physics simulation to generate the training elevation maps and other data. The images resulting from the physics simulation 130 form the ideal elevation maps (ground truth elevation maps) and other representations for training the NN algorithm and are subsequently stored. The renderer uses a scene with the information from the physics simulation results, virtually places the 3D scanner at a random position with a random viewing direction (all within given, reasonable limits so that the container is in the field of view) and renders a series of different virtual images from the viewpoint of a reference camera of the 3D scanner. To do this, the renderer may use the sensor calibration of the type of scanner used to localize the objects (e.g. scanner MiniPICK from ISRA VISION GmbH). The following images may be created for each scene using rendering (see scene in FIG. 18):
(a) Camera visibility image (see FIG. 19): Each pixel encodes the number of cameras in which it is visible (i.e. not covered). This information is used to determine the pixels that a real scanner might reconstruct, as at least two cameras are required for 3D triangulation.
(b) Ideal elevation map (see FIG. 20): The pixels encode the elevation of the viewed surface with 16 bits corresponding to the elevation range covered after 3D scanner calibration.
(c) Ideal object coordinate map (see FIG. 21): The pixels encode the object coordinates according to the color coding of the data model described above as an ideal object coordinate map, wherein a representation of the colors is not possible within the scope of the present application and is replaced by a gray value representation.
(d) Object ID map (see FIG. 22): Grayscale image with 32 bits per pixel, in which each object (partial instance) is evenly colored with a shade of gray that corresponds to a unique object ID. An ideal segmentation mask may be derived from this.
(e) Occlusion ratio map (see FIG. 23): Grayscale image in which each object is evenly colored in the ratio in which it is covered by other objects. The darker the proportion, the less covered it is. This information is used to determine which objects may be selected for evaluation by the NN algorithm.

Said images/maps may subsequently be stored in step 140 so that the information can be retrieved during training of the NN algorithm.

Before the training data generation is completed, the symmetry of the data model of the object is determined for each object type in step 136. In particular, rotational symmetries of the objects may be found. This information is required later by the loss function of the training procedure. The symmetry information obtained is stored in step 137 and made available to the training data stored in step 140.

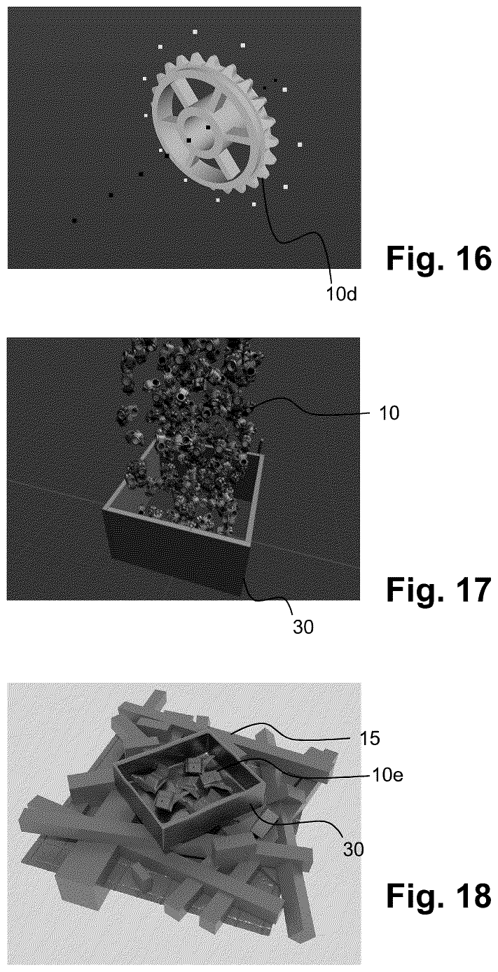

FIGS. 13 to 15 show examples of different objects, wherein the object 10a illustrated in FIG. 13 comprises no rotational symmetry, the object 10b shown in FIG. 14 comprises discrete symmetry axes and the cylinder (object 10c) shown in FIG. 15 comprises continuous symmetry. A determined axis of symmetry of a further object (gear wheel 10d) is illustrated in FIG. 16 with the aid of small black squares arranged on the axis of symmetry. The object comprises a discrete symmetry at certain angles of rotation, which are illustrated by the light squares distributed around the circumference. The determination of symmetry may be facilitated by using a predefined number of symmetry axes for the respective object type.

For the training, which will be explained below using the flowchart in FIG. 7, training data that simulates real data may now be generated from the ideal data obtained above (ideal elevation map, ideal object coordinate map), as already described above, in an embodiment of the training method. For this purpose, the ideal data is loaded from the memory in step 141 and modified in step 142 by means of one or more of the modification functions listed and explained above. The resulting training images, in particular training elevation maps, are then used in the training of the NN algorithm (illustrated by box 170 in FIG. 7). Examples of training elevation maps that have been formed from an ideal elevation map shown in FIG. 24 using a modification function are shown in FIGS. 25 to 28.

Information on the NN algorithm is also required for training. This information on an NN algorithm, which may, for example, be based on a U-Net architecture (see FIG. 29), is provided in step 151. In step 151, the NN algorithm is created and made available to the training method 170 in step 155. The NN algorithm may comprise, for example, the structure described in more detail above as a CNN. The training includes the prediction of the desired images/maps from the training elevation maps using the NN algorithm in step 171, the determination of the loss function for the predicted images/maps in step 172 and the optimization of the parameters of the neural network underlying the NN algorithm in step 173 in order to minimize the loss calculated with the loss function. The training is then continued with the correspondingly modified NN algorithm (illustrated by arrow 174), in each case with an adapted NN algorithm, until a predefined termination criterion is reached. The training is carried out in relation to the at least one object type that is to be arranged and removed from the container in the bin-picking task. The trained NN algorithm is then stored in step 75 and provided to the locating method for predicting the object coordinate map and the segmentation mask based on the current elevation map of the observed area of the object cluster.

The determination of the loss function during the training of the NN algorithm 70 is illustrated in FIG. 30 and in more detail in FIG. 31.

An object coordinate map 92a and a segmentation map 94a are predicted from a training elevation map 191 using the NN algorithm 70. These maps 92a, 94a are compared with the ideal object coordinate map 92gt and the ideal segmentation map 94gt and the loss is determined using the loss function (step 172). In the optimization step 173, those parameters of the NN algorithm are determined which must be changed in order to achieve a minimization of the loss determined with the loss function. The NN algorithm 70 is adapted accordingly and the training is continued with the next training elevation map 191.

FIG. 31 shows an example of calculating the loss from the loss function. In this embodiment, the total loss 172t is composed of a mask loss 172m, a prediction loss 172cf and an object coordinate loss 172oc. Here, the calculation of the loss function of FIG. 31 refers to an embodiment in which, as explained above, the segmentation mask for each pixel contains not only information about the association with a segment but also information about the level of the prediction reliability in relation to the position of the pixel in object coordinates.

Input variables of the mask loss function 172f1 are therefore formed from the ideal segmentation mask 94gt and the predicted segmentation mask 94a, namely the information part 94a1 of the predicted segmentation mask 94a, which contains the association of the pixel with one segment and is contained, for example, in the value range [0.0; 0.5]. Furthermore, an input variable forms the weighting function 75a shown in FIG. 33. The mask loss is an important factor for the differentiation of objects in a 3D scan. This is done by identifying connected image elements. The loss is calculated as the sum of the squared difference between the predicted segmentation mask 94a (from information part 94a1) and the ideal segmentation mask 94gt. The pixel-based losses are also multiplied by the weighting function 75a, which causes the boundary pixels of the object to have a greater influence on the mask loss 172m and thus on the total loss 172t. This embodiment is advantageous to ensure correct prediction of the boundary regions of an object and to avoid segmentation errors, which may quickly degrade the detection performance. The result is then normalized in relation to the number of pixels in the image.

To determine the prediction reliability loss 172cf, the loss function 172f3 is derived from the prediction reliability loss proportion 94a2 of the predicted segmentation mask 94a and the value derived from the loss function of the object coordinate map 172f2, which is calculated per pixel, as step 176 indicates.

Finally, the proportion of the object coordinate loss 172oc is calculated from a comparison of the ideal object coordinate map 92gt and the predicted object coordinate map 92a. The segment of each object is iterated and the defect of the coloring of the predicted object coordinate map is calculated over all pixels belonging to the respective object (so-called L2 norm). In this case, there is the challenge that symmetrical objects may occur. These objects may comprise several congruent poses for which the geometry is the same but the coloring is different. Therefore, the object coordinate loss function 172f2 checks the loss for each symmetry of the object 10 in question separately and uses only the smallest loss for the respective object as the object coordinate loss 172oc and to calculate the total loss 172t.

The total loss 172t results from the sum of the mask loss 172m, the previous prediction reliability loss 172cf and the object coordinate loss 1720c.

After processing each training altitude map 191, such a total loss 172t is determined. Based on the total loss 172t, the parameters of the NN algorithm 70 are adjusted to minimize the loss 172t.

With such a trained NN algorithm 70, the device 20 may easily, safely and quickly identify objects 10 in an object cluster 40 that may be removed from the cluster. Furthermore, their position and orientation (pose) may be determined, which may be transmitted to a control device 60 of the gripping and/or transport element 50 via the interface 22. Based on the poses of the respective objects, the control device may determine trajectories of the movement of the gripping and/or transport element 50, along which the gripping and/or transport element may be moved for removal.

FIG. 34 shows an object 10 and a device 220 for automatically locating such objects 10 from an observed area of a cluster 240 of objects present on a conveyor belt 230. The objects 10 are schematically shown as simple cylinders on the conveyor belt 230, but these are intended to comprise the shape shown at the top left of this figure. The method operates, for example, when the first of the objects 10 lying on the conveyor belt 230 passes past a light barrier (not shown). By means of a corresponding signal from this light barrier, the elevation map is determined in the observed area, transmitted and received by the device 220. The identification of the objects 10 in the object cluster 240 and the determination of their respective 3-dimensional position and orientation is performed analogously to the bin-picking procedure indicated above for each elevation map received. When objects 10 in the object cluster 240 have been identified and their respective 3-dimensional position and orientation (pose) has been determined by the device 220, the data on the position and orientation of the objects 10 may be transmitted by means of a corresponding interface 222 of the device to a gripping and/or transport element 250, for example a robot end effector, with a control device 260. Here, for example, the 3-dimensional position and orientation of the objects of the observed area of the conveyor belt 230 are determined every ½ second (every five tenths of a second) in order to take into account the movement of the objects on the conveyor belt as well as the movement of the gripping and/or transport element. The control device 260 further processes the transmitted position and orientation data of the objects 10 identified in the observed area of the conveyor belt 230 and determines movement trajectories for the gripping and/or transport element 250, for example in the object coordinate system. If the gripping and/or transport element 250 moves along these trajectories, the gripping and/or transport element may remove identified objects 10 individually from the conveyor belt 230 and transport them, for example, to a parallel running second conveyor belt (not shown) and place them there, for example at a predetermined distance from the preceding object 10, for example for further processing of the object 10. The object cluster 40 is located on the conveyor belt 230 and comprises a plurality of objects 10 arranged in a random or ordered arrangement on top of one another or adjacently standing upright or lying. In the embodiment shown in FIG. 34, only a single object type is included as object 10 in the object cluster 240, namely the component shown at the top left in FIG. 1. However, different object types may also be used in the object cluster 240, wherein no object, one object or several objects of each object type may be present in the object cluster 240. Alternatively, instead of the gripping and/or transporting element 250, a robotic element (actuator) 250 may be used, which takes up one or more predetermined position(s) relative to one object with respect to objects of the object cluster 240, wherein the multiple positions form a sequence of movements. For example, the robotic element may be configured to and its movement controlled by the control device 260 such that it mounts a component at a particular position of the object or joins a component to the object. In the procedure described above, the control device 260 determines the object 10 which is transported at the current time point by means of the gripping and/or transport element or with respect to which the robot element takes predetermined positions relative to the object at the respective time point. As a rule, the control device 260 will select the object 10 for transport or with regard to the relative movement of the robot element which comprises the most favorable position with regard to the activity of the gripping and/or transport element or the robot element.

1. A method for automatically locating objects of an observed area of an object cluster consisting of a plurality of objects of at least one object type arranged one above the other and/or adjacently, comprising the following steps:
Receiving a data model of the at least one object type, for example in the form of a colored coordinate model,
Receiving an NN algorithm trained for the specific at least one object type, wherein the NN algorithm is trained based on the data model of the at least one object type,
Receiving an elevation map of the observed area of object cluster,
Identifying a plurality of objects arranged in the observed area of the object cluster and determining the 3-dimensional position and orientation of said plurality of objects in a predetermined coordinate system by a data processing unit based on the NN algorithm trained with respect to the at least one object type using the data model of the at least one object type and using exclusively the elevation map of the observed area of the object cluster with respect to the observed area, and
Providing the 3-dimensional position and orientation of the plurality of objects arranged in the observed area of the object cluster at an interface of the data processing unit.

2. The method according to claim 1, wherein an object coordinate map of the object cluster and a segmentation mask of the object cluster are determined from the elevation map of the object cluster by means of the NN algorithm for identifying and determining the position and orientation of the plurality of objects arranged in the observed area of the object cluster, wherein the object coordinate map contains the position of pixels in object coordinates of the respective object and the segmentation mask for each pixel contains information about the association of the pixel with one segment of a plurality of segments.

3. The method according to claim 2, wherein the segmentation mask is applied to the object coordinate map, by this application individual objects are identified as being arranged in the observed area of the object cluster and pixels of the object coordinate map and the elevation map belonging to the corresponding object are determined, wherein from this the 3-dimensional coordinates in a predetermined coordinate system and the 3-dimensional coordinates in the coordinate system of the respective object are determined for each pixel belonging to an identified object, and in each case the 3-dimensional position and orientation of these identified objects in the predetermined coordinate system is determined from the coordinate pairs of all pixels of the respective identified object determined in this way, and/or
wherein the elevation map of the observed area of the cluster is determined and transmitted by means of a 3D scanner.

4. The method according to claim 1, wherein the method is configured to locate objects of the observed area suitable for removal, wherein the observed area of the object cluster is arranged in an open container, and the object cluster consists of objects lying on top of each other, wherein the identified plurality of objects, determined with respect to their 3-dimensional position and orientation, lies on the top side of the observed area of the object cluster.

5. A method for controlling a movable gripping and/or transporting element for removing an object from an object cluster present in an open container and consisting of a plurality of objects of at least one object type lying one above the other,
wherein the method comprises said method for automatically locating objects according to claim 4,
wherein the 3-dimensional position and orientation of the objects lying on the top side of the observed area of the object cluster is transmitted to a control element of the gripping and/or transporting element, and
wherein corresponding control signals for the movement of the gripping and/or transporting element for removing the corresponding object from the container are calculated by the control element from the transmitted 3-dimensional position and orientation of the objects, at least for a subset of the objects lying on the top side.

6. The method according to claim 1, wherein the method is configured to localize objects moving in the observed area, wherein at one predetermined time point or several predetermined time points the elevation map of the observed area of the object cluster is received, the plurality of objects arranged in the observed area is identified and their 3-dimensional position and orientation is determined and provided at the interface of the data processing unit.

7. A method for controlling a movable gripping and/or transporting element for manipulating an object from an object cluster consisting of a plurality of objects of at least one object type arranged one above the other and/or adjacently,
wherein the method comprises said method for automatically locating objects according to claim 6,
wherein the 3-dimensional position and orientation of the objects arranged in the observed area of the object cluster are transmitted to a control element of the gripping and/or transporting element after provision at the interface, and
wherein corresponding control signals for the movement of the gripping and/or transport element for manipulating the corresponding object are calculated from the transmitted 3-dimensional position and orientation of the objects at least for a subset of the objects by the control element.

8. A method for controlling a movable robot element for taking a predetermined position relative to an object from an object cluster consisting of a plurality of objects of at least one object type arranged one above the other and/or adjacently,
wherein the method comprises said method for automatically locating objects according to claim 6,
wherein the 3-dimensional position and orientation of the objects arranged in the observed area of the object cluster is transmitted to a control element of the robot element after provision at the interface, and
wherein corresponding control signals for the movement of the robot element to take the predetermined position relative to the corresponding object are calculated from the transmitted 3-dimensional position and orientation of the objects at least for a subset of the objects by the control element.

9. A device for automatically locating objects from an observed area of an object cluster consisting of a plurality of objects of at least one object type arranged adjacently and/or one above the other, having a data processing unit which is configured to:
Receive a data model of the at least one object type,
Receive an NN algorithm trained for the specific at least one object type, wherein the NN algorithm is trained based on the data model of the at least one object type,
Receive an elevation map of the observed area of the object cluster,
Identify a plurality of objects arranged on the top side of the object cluster in the observed area of the object cluster and determining the 3-dimensional position and orientation of said plurality of objects in a predetermined coordinate system based on the NN algorithm trained with respect to the at least one object type using the data model of the at least one object type and using exclusively the elevation map of the observed area of the object cluster with respect to the observed area, and
Provide the 3-dimensional position and orientation of the plurality of objects arranged on the top side of the object cluster in the observed area of the object cluster at an interface of the data processing unit.

10. The device according to claim 9, wherein the data processing unit is configured to determine an object coordinate map of the object cluster and a segmentation mask of the object cluster from the elevation map of the object cluster using the NN algorithm for identifying and determining the position and orientation of the plurality of objects arranged in the observed area of the object cluster, wherein the object coordinate map contains the position of pixels in object coordinates and the segmentation mask for each pixel contains information about the association of the pixel with one segment of a plurality of segments, and/or
wherein the data processing unit is configured to apply the segmentation mask to the object coordinate map, to identify individual objects by the application as being arranged in the observed area of the object cluster and to determine pixels of the object coordinate map and of the elevation map belonging to the corresponding object, wherein it determines from this the 3-dimensional coordinates in a predetermined coordinate system and the 3-dimensional coordinates in the coordinate system of the respective object for each pixel belonging to an identified object, and determines in each case the 3-dimensional position and orientation of these identified objects in the predetermined coordinate system from the coordinate pairs of all pixels of the respective identified object determined in this way, and/or
wherein the device additionally comprises a 3D scanner which determines the elevation map of the observed area of the cluster and transmits it to the data processing unit.

11. The device according to claim 9, wherein the device is configured to locate objects of the observed area suitable for removal, wherein the observed area of the object cluster is arranged in an open container, and the object cluster consists of objects lying on top of each other, wherein the identified plurality of objects, determined with respect to their 3-dimensional position and orientation, lies on the top side of the observed area of the object cluster.

12. A system for controlling a movable gripping and/or transporting element for removing an object from an observed area of an object cluster present in an open container and consisting of a plurality of objects of at least one object type lying one above the other, wherein the system comprises:
the device according to claim 11, and
a control device,
wherein the data processing unit of the device transmits the 3-dimensional position and orientation of the objects lying on the top side of the observed area of the object cluster to the control device, and
wherein the control device determines corresponding control signals for the movement of the gripping and/or transporting element for removing the corresponding object from the container from the transmitted 3-dimensional position and orientation of the objects, at least for a subset of the objects lying on the top side, and moves the gripping and/or transporting element in accordance with the determined control signals.

13. The device according to claim 9, wherein the device is configured to locate objects moving in the observed area, and wherein the device is configured to repeatedly receive the elevation map of the observed area of the object cluster at one predetermined time point or at several predetermined time points, to identify the plurality of objects arranged in the observed area and to determine their 3-dimensional position and orientation and to provide them at the interface of the data processing unit.

14. A system for controlling a movable gripping and/or transporting element for manipulating an object from an object cluster consisting of a plurality of objects of at least one object type arranged one above the other and/or adjacently, wherein the system comprises:
the device according to claim 13, and
a control device,
wherein the data processing unit of the device is configured to transmit the 3-dimensional position and orientation of the objects arranged in the observed area of the object cluster to the control device of the gripping and/or transporting element, and
wherein the control device is configured to determine, from the transmitted 3-dimensional position and orientation of the objects, corresponding control signals for the movement of the gripping and/or transporting element for manipulating the corresponding object, at least for a subset of the objects, and to move the gripping and/or transporting element in accordance with the determined control signals.

15. A system for controlling a movable robot element so that it takes a predetermined position relative to an object from an object cluster consisting of a plurality of objects of at least one object type arranged one above the other and/or adjacently, wherein the system comprises:
the device according to claim 13, and
a control device,
wherein the data processing unit of the device is configured to transmit the 3-dimensional position and orientation of the objects arranged in the observed area of the object cluster to the control device of the robot element, and
wherein the control device is configured to determine from the transmitted 3-dimensional position and orientation of the objects, at least for a subset of the objects, corresponding control signals for the movement of the robot element to take the predetermined position relative to the corresponding object and to move the robot element in accordance with the determined control signals.

16. A method for machine training an NN algorithm for identifying and locating objects from an observed area of an object cluster by a data processing unit comprising the following steps:
a) Using a physical model for arranging a predetermined number of objects of at least one object type, each corresponding to the data model of this object type, in a container in such a way that a ground truth object cluster is created from the predetermined number of objects,
b) Rendering an ideal elevation map of the observed area of the object cluster based on the ground truth object cluster,
c) Rendering an ideal object coordinate map of the observed area of object clustering based on the ground truth object clustering,
d) Rendering an ideal segmentation mask of the observed area of object clustering based on the ground truth object clustering,
e) Modifying the ideal elevation map using a first modification function to produce a training elevation map,
f) Determining a predicted object coordinate map and a predicted segmentation mask from the training elevation map using the current version of the NN algorithm for the observed area of object cluster,
g) Determining a loss using a loss function from a comparison of the predicted object coordinate map with the ideal object coordinate map and from a comparison of the predicted segmentation mask with the ideal segmentation mask,
h) Modifying the NN algorithm to minimize the value of the loss function,
i) Repeating steps e) to h) with different modification functions which differ from the first modification function and/or steps a) to h) with different numbers of objects of the same at least one object type and/or different orientation of the container and/or different observation areas of the container until a termination criterion is reached, and
j) Storing the last version of the trained NN algorithm in a data memory of the data processing unit.

17. The method according to claim 16, wherein the NN algorithm is based on a U-Net architecture, and/or
wherein, when determining the loss of the loss function, any symmetry existing, if applicable, in an object type is taken into account, wherein the loss is determined as the loss of the loss function in which the object coordinate map loss function proportion is minimal for different positions of the respective object with respect to the symmetry, and/or
wherein, when determining the loss of the loss function, the pixels of the object boundaries of the predicted segmentation mask are weighted more heavily than the other pixels by multiplication with a weighting function, and/or
wherein the predicted segmentation mask additionally contains for each pixel a prediction certainty information resulting from the object coordinate map loss function proportion of the loss function.

18. The method according to claim 3, wherein the segmentation mask for each pixel may additionally contain the information as to the level of the prediction reliability in relation to the position of the pixel in object coordinates.

19. The method according to claim 1, wherein the NN algorithm is based on a U-Net architecture, and/or
wherein, when determining the loss of the loss function, any symmetry existing, if applicable, in an object type is taken into account, wherein the loss is determined as the loss of the loss function in which the object coordinate map loss function proportion is minimal for different positions of the respective object with respect to the symmetry, and/or
wherein, when determining the loss of the loss function, the pixels of the object boundaries of the predicted segmentation mask are weighted more heavily than the other pixels by multiplication with a weighting function, and/or
wherein the predicted segmentation mask additionally contains for each pixel a prediction certainty information resulting from the object coordinate map loss function proportion of the loss function.

20. The method according to claim 5, wherein the NN algorithm is based on a U-Net architecture, and/or
wherein, when determining the loss of the loss function, any symmetry existing, if applicable, in an object type is taken into account, wherein the loss is determined as the loss of the loss function in which the object coordinate map loss function proportion is minimal for different positions of the respective object with respect to the symmetry, and/or
wherein, when determining the loss of the loss function, the pixels of the object boundaries of the predicted segmentation mask are weighted more heavily than the other pixels by multiplication with a weighting function, and/or
wherein the predicted segmentation mask additionally contains for each pixel a prediction certainty information resulting from the object coordinate map loss function proportion of the loss function.
